(19) United States
(12) Patent Application Publication
(10) Pub. No.: US 2024/0181687 A1
(43) Pub. Date: Jun. 6, 2024

(54) METHOD FOR FILLING A MOLDING TOOL CAVITY OF A MOLDING TOOL FOR PRODUCING A MOLDED PARTICLE FOAM PART WITH PARTICLE FOAM MATERIAL

(71) Applicant: Siegfried Hofmann GmbH, Lichtenfels (DE)

(72) Inventors: Johannes SCHÜTZ, Lichtenfels (DE); Patrick FISCHER, Lichtenfels (DE); Thomas KLUGE, Lichtenfels (DE)

(21) Appl. No.: 18/556,375

(22) PCT Filed: Mar. 31, 2022
(86) PCT No.: PCT/EP2022/058547

§ 371 Date: Oct. 20, 2023

(30) Foreign Application Priority Data
Apr. 22, 2021 (DE) 10 2021 110 356.8

(51) Int. Cl. B29C 44/44; B29C 44/02; B29C 44/42; B29C 44/60; B29K 105/04

(52) U.S. Cl. CPC B29C 44/445; B29C 44/02; B29C 44/425; B29C 44/428; B29C 44/60; B29K 2105/048

(57) ABSTRACT

A method for filling a mold cavity of a mold for producing a particle foam molding using particle foam material includes providing particle foam material, to be processed in a mold cavity of a mold for producing a particle foam molding, via at least one filling container device, wherein there is a first pressure level in the filling container device. The method also includes providing a mold cavity which is to be filled with a particle foam material that is to be processed for producing the or a particle foam molding, wherein there is a second pressure level in the mold cavity, and filling the mold cavity with particle foam material from the filling container device, wherein during the filling of the mold cavity a difference between the first pressure level and the second pressure level is purposefully varied by at least one measure for varying the difference between the first pressure level and the second pressure level.

The invention relates to a method for filling a mold cavity of a mold for producing a particle foam molding using particle foam material.

Methods and devices for producing particle foam moldings by processing expandable or expanded particle foam materials are known in principle from the prior art in a number of different embodiments.

In this connection, methods for filling the mold cavity of molds for producing a particle foam molding using particle foam material are also known, as these constitute a basic prerequisite for the further processing of corresponding particle foam materials for producing corresponding particle foam moldings.

Within the scope of corresponding methods for filling the mold cavity of molds for producing a particle foam molding using particle foam material, hitherto the particle foam material is typically filled into the respective mold cavities at comparatively high pressure and, associated therewith, comparatively high speed.

Even if the principle leads essentially to satisfactory results with respect to the particle foam moldings that can be produced thereby, there is a need for a development of improvement of principles for filling corresponding mold cavities with particle foam material, for example in view of aspects such as higher filling densities or levels of the mold cavities and, associated therewith, higher molding weights of the particle foam moldings that can be produced.

The object of the invention is that of specifying an improved method for filling a mold cavity of a mold for producing a particle foam molding using particle foam material.

The object is achieved by the subjects of the independent claims. The claims dependent thereon relate to possible embodiments of the subjects of the independent claims.

Any pressure difference between a filling container device and the respective mold cavity is typically not taken into account.

A first aspect of the invention relates to a method for filling a mold cavity of a mold for producing a particle foam molding using particle foam material. The method is accordingly directed to a filing process for filling a mold cavity of a mold for producing a particle foam molding using particle foam material.

The method can thus comprise one or more independent work processes within the context of an overarching method for processing particle foam material to produce a particle foam molding. Corresponding work processes can be or comprise for example provision processes in which an amount of particle foam material to be processed, in particular an amount of particle foam material to be processed in a processing procedure, is provided, conveying processes in which an amount of particle foam material, in particular an amount of particle foam material to be processed in a processing procedure, is conveyed along a conveying path in the direction of a mold cavity, and filling processes in which an amount of particle foam material, in particular an amount of particle foam material to be processed in a processing procedure, is filled into a mold cavity.

According to the method, in principle all the particle foam materials that can be processed within the context of a corresponding overarching method for processing particle foam material to produce a particle foam molding can be filled into a mold cavity. Corresponding particle foam materials are in general expandable or expanded plastics particles (“plastics particles”) consisting of at least one expandable or expanded plastics particle material (“plastics particle material”). According to the method, expandable or expanded plastics particles, e.g. based on polypropylene (PP or EPP), expanded and/or expandable polyamide (PA or EPA), expanded and/or expandable polystyrene (PS or EPS), and expanded and/or expandable thermoplastic elastomer (TPE), in particular expanded and/or expandable thermoplastic polyurethane (TPU), can be filled into a mold cavity. In the same way, according to the method, particle foam materials based on what are known as biomaterials, i.e. plant-based expandable or expanded plastics particles, e.g. based on polysaccharide, i.e. for example based on starch or sugar, can be filled into a mold cavity.

The individual steps of the method are explained in the following:

In a first step of the method, particle foam material, to be processed in a mold cavity of a mold for producing a particle foam molding is provided via at least one filling container device, wherein there is a first pressure level in the filling container device. Thus, in the first step, at least one filling container device filled with particle foam material is provided. The particle foam material is furthermore to be filled into at least one mold cavity of a mold, within the context of a filling process, and, after completion of the filling process, to be processed in the mold cavity for producing a particle foam molding, within the context of a, for example steam-based, processing procedure. The filling container device, which is designed for example as a pressure vessel or comprises at least one such vessel, comprises a filling container volume which can be or is filled with particle foam material and in which, in any case in the state filled with particle foam material, a pressure level referred to in the following as “first pressure level”, and thus a specified first pressure, prevails.

In a second step of the method, at least one mold cavity which is to be filled with a particle foam material that is to be processed for producing the or a particle foam molding is provided, wherein there is a second pressure level in the mold cavity. Thus, in the second step, at least one mold cavity, which can be or is to be filled with particle foam material from the filling container device, is provided. The particle foam material that is to be or is filled into the mold cavity within the context of a corresponding filling process is, as mentioned, to be processed, after completion of the filling process, in the mold cavity for producing a particle foam molding, within the context of a, for example steam-based, processing procedure. The mold cavity, which is defined by a plurality of mold elements, which are also referred to in each case as mold halves, comprises a mold cavity volume which can be or is filled with particle foam material and in which, in any case in the state not filled with particle foam material, a pressure level referred to in the following as “second pressure level”, and thus a specified second pressure, prevails.

The first and the second step of the method can also be carried out simultaneously or in reverse order; all that is important, for carrying out the method, is that particle foam material, to be processed in a mold cavity of a mold for producing a particle foam molding, is provided via at least one filling container device, wherein there is a first pressure level in the filling container device, and that a mold cavity, to be filled with particle foam material to be processed for producing the or a particle foam molding, is provided, wherein there is a second pressure level in the mold cavity.

As emerges in the following, the pressure levels within the filling container device and within the mold cavity can differ within the context of a filling process, i.e. during the filling of the mold cavity with particle foam material. In particular, within the context of a corresponding filling process the second pressure level can differ from the first pressure level in that it is below the first pressure level.

In a third step of the method, the mold cavity is filled with particle foam material from the filling container device. Accordingly, in the third step of the method a corresponding filling process is carried out, within the scope of which particle foam material from the filling container device is filled into the mold cavity, and therefore the mold cavity is filled with particle foam material from the filling container device.

According to the method, the filling of the mold cavity, and therefore while carrying out a corresponding filling process, within the context of which particle foam material is conveyed from the filling container device into the mold cavity, a difference between the first pressure level and the second pressure level is purposefully varied or changed by at least one measure for varying or changing the difference between the first pressure level and the second pressure level. Thus, according to the method, existing differences between the first and the second pressure level are varied or changed in a purposeful manner during the filling of the mold cavity. The purposeful variation or change of corresponding differences between the first and the second pressure level is performed with the aim of an improved filling process which allows in particular higher filling densities or levels of the mold cavity and, associated therewith, higher molding weights of the particle foam moldings that can be produced.

The principle according to the method makes it possible, by means of corresponding purposeful variation or change of the or a difference between corresponding pressure levels, in particular to implement a controlled or regulated volume flow of a particle foam material from the or a filling container device into the or a mold cavity. The speed at which the particle foam material is conveyed into the mold cavity, within the context of a filling process, can be controlled or regulated in a corresponding manner. The individual plastics particles can be conveyed into the mold cavity at greater compression and/or slower speed by the purposeful variation or change in the difference between the pressure levels, which can be understood to mean, as is clear in the following, also a matching of the pressure levels following a previous purposeful change or increase in the difference of the pressure levels, which results in an improved, because it is more densely packed, filling of the mold cavity. Specifically, more significantly compressed plastics particles, which are conveyed into the mold cavity at lower speed, for example collect better in corners of the mold cavity, such that said corners, as well as other regions of a mold cavity that can typically be filled only with difficulty, such as regions far away from a filling opening of a mold element, can be filled in a significantly more controllable and reproducible manner, with high filling densities or levels, by means of the principle according to the method.

As is clear in the following, the at least one measure for purposeful variation or changing of the difference between corresponding first and second pressure levels can presuppose a, for example sensor-based, detection of corresponding first and second pressure levels, such that, proceeding from specifically detected first and second pressure levels and, associated therewith, a specifically detected difference between corresponding pressure levels, a purposeful variation or change of the difference between the pressure levels can take place.

As is likewise clear in the following, the at least one measure for purposeful variation or changing of the difference between corresponding first and second pressure levels can be implemented by means of control or regulation technology. In particular, for purposeful variation or change of the difference between corresponding pressure levels, active or passive pressure-influencing devices, e.g. in the form of valve devices that are controllable or regulatable with regard to their operation, i.e. in particular control or regulation valve devices, or proportional valve devices, can be implemented or used, the operation of which is controlled or regulated in a particular manner, for example, for purposeful variation or change of the difference between corresponding pressure levels. Corresponding pressure-influencing devices can be assignable or assigned to the filling container device and/or the mold cavity. The at least one measure for purposeful variation or changing of the difference between corresponding first and second pressure levels can thus comprise for example control or regulation of the operation of corresponding pressure-influencing devices.

The control or regulation of the operation of corresponding pressure-influencing devices, which, as mentioned, can in particular be corresponding valve devices, can include, in all embodiments, a specification of control or regulation information describing a lifting movement or a lifting process of at least one lifting element, mounted so as to be movable along a lifting path, of a corresponding controllable or regulatable pressure-influencing device, and the implementation of corresponding lifting movements or lifting processes of a corresponding lifting element, on the basis of corresponding control or regulation information.

Thus, overall, an improved method for filling a mold cavity of a mold for producing a particle foam molding using particle foam material is provided.

According to the method, the at least one measure for purposefully varying or changing the or a difference between the first pressure level and the second pressure level during the filling of the mold cavity can include setting a defined difference, which can be changed, in particular in a time-dependent and thus dynamic manner, between the first pressure level and the second pressure level. Within the context of the implementation of the at least one measure, differences between the first pressure level and the second pressure level which can be changed in a purposeful manner, in particular in a time-dependent manner, can thus be achieved during filling of the mold cavity. This can in general likewise be implemented for example by a control or regulation, taking place in particular in a time-dependent and thus dynamic manner, of the operation of corresponding pressure-influencing devices.

The setting of corresponding differences, which can be changed in a time-dependent manner, between the first pressure level and the second pressure level during the filling of the mold cavity can include for example a time-dependent increase or decrease in the or a pressure difference between the first pressure level and the second pressure level. A corresponding sometimes time-dependent increase or decrease in the or a pressure difference between the first pressure level and the second pressure level can be continuous or non-continuous, or linear or non-linear. Specifically, e.g. the second pressure level can in particular be increased or decreased relative to the first pressure level, in particular in a continuous or non-continuous, or linear or non-linear manner; the first pressure level does not necessarily have to be changed in the process. Therefore, a ramp-like or ramp-shaped increase or decrease in the first and/or second pressure level from a (respective) first pressure value (starting pressure value) to a (respective) higher or lower second pressure value (end pressure value) is to be cited as an example for a continuous or linear increase or decrease in the or a pressure difference between the first pressure level and the second pressure level. This can take place e.g. by means of a ramp-like or ramp-shaped increase or decrease of the second pressure level relative to the first pressure level; as mentioned, the first pressure level does not necessarily have to be changed in the process. A corresponding increase or decrease of a respective pressure level can take place in a range between 1 and 90%, more particularly in a range between 1 and 80%, more particularly in a range between 1 and 70%, more particularly in a range between 1 and 60%, more particularly in a range between 1 and 50%, more particularly in a range between 1 and 40%, more particularly in a range between 1 and 30%, more particularly in a range between 1 and 20%, more particularly in a range between 1 and 10%. An increase or decrease of a respective pressure level can be implemented in general for example via a controlled or regulated operation of at least one pressure-influencing device for implementing a corresponding ramp-like or ramp-shaped increase or decrease of the second pressure level.

The setting of a defined difference, which can be changed, in particular in a time-dependent manner, between the first pressure level and the second pressure level, during the filling of the mold cavity, can in particular include a ramp-like or ramp-shaped continuous reduction of the second pressure level from a defined, starting pressure value, typically selected in a particle foam-specific and/or mold-specific manner, before or at the start of the filling of the mold cavity, to a defined end pressure value after a defined time interval, likewise typically selected in a particle foam-specific and/or mold-specific manner, has elapsed after the start of the filling of the mold cavity. The setting of a defined difference, which can be changed, in particular in a time-dependent manner, between the first pressure level and the second pressure level can thus take place, according to the method, already before or immediately at the start of the filling of the mold cavity, and thus before or immediately at the start of a filling process.

According to the method, the at least one measure for varying the difference between the first pressure level and the second pressure level during the filling of the mold cavity can include, in particular additionally, setting a defined difference, which cannot be changed, in particular in a time-dependent manner, between the first pressure level and the second pressure level. A corresponding setting, which is unchangeable, in particular, in a time-dependent manner, of a defined unchangeable difference between the first pressure level and the second pressure level, can thus include maintaining a constant difference and thus, in any case in view of the compression of the plastics particles and/or the speed of the plastics particles, the occasional implementation of a stationary filling process. This can be implemented in general for example via a corresponding controlled or regulated operation of at least one pressure-influencing device for setting a difference, which is unchangeable, in particular in a time-dependent manner, between the first pressure level and the second pressure level.

According to the method, combinations of the above-mentioned possibilities for purposeful influencing or varying of a difference between a first and a second pressure level are conceivable.

The at least one measure for varying the difference between the first pressure level and the second pressure level during the filling of the mold cavity can thus include for example firstly setting a defined difference, which can be changed in a time-dependent manner, between the first pressure level and the second pressure level, over a first time interval, in particular directly, during or after the start of the filling, and, after the first time interval has elapsed, setting a defined difference, which is unchangeable, in particular in a time-dependent manner, between the first pressure level and the second pressure level. Therefore, a purposeful time-dependent change of the difference between the first pressure level and the second pressure level, i.e. in particular an increase in the difference between the first pressure level and the second pressure level, can take place immediately during or after the start of the filling of the mold cavity, initially for a first time interval, and then, in particularly immediately, after the first time interval has elapsed, maintenance of a difference, present after the first time interval has elapsed, between the first pressure level and the second pressure level, can take place. This can be implemented in general for example via a corresponding controlled or regulated operation of at least one pressure-influencing device, initially for setting a defined difference, which can be changed in a time-dependent manner, between the first pressure level and the second pressure level, over a first time interval after the start of the filling, and after the first time interval has elapsed, setting a defined difference, which is unchangeable, in particular in a time-dependent manner, between the first pressure level and the second pressure level.

According to the method, the setting of a defined difference, which can be changed and/or is unchangeable, in particular in a time-dependent manner, between the first pressure level and the second pressure level, during the filling of the mold cavity, can in particular include a purposeful matching or setting of (only) the second pressure level from a starting value before or at the start of the filling of the mold cavity, i.e. before the start of a corresponding filling process, to a defined end value after a defined time interval has elapsed after the start of the filling of the mold cavity, i.e. after the start of a corresponding filling process. Therefore, according to the method, the pressure level within the mold cavity can be purposely varied or changed during the filling of the mold cavity. Alternatively or additionally, however, the pressure level within the filling container device and/or within a line connection that connects the filling container device to the mold cavity, and/or within a filling device that is for example formed as a filling nozzle or comprises at least one such nozzle, can be purposely varied or changed.

At this point, it should be noted again that the at least one measure for purposefully influencing or varying the difference between the first pressure level and the second pressure level during the filling of the mold cavity can be carried out by controlling or regulating the operation of at least one controllable or regulatable pressure-influencing device, in particular in the form of a valve device, which is assigned to the filling container device and/or the mold cavity. Alternatively or in addition, control or regulation of the operation of at least one line connection that connects the filling container device to the mold cavity, and/or of a controllable or regulatable pressure-influencing device, in particular in the form of a valve device, which is assigned to a filling device that is formed for example as a filling nozzle or comprises at least one such nozzle, is conceivable.

The control or regulation of the operation of the respective controllable or regulatable pressure-influencing device can, as indicated above, be carried out on the basis of detection data that describe the pressure level within the filling container device, and/or within the mold cavity, and/or within a line connection that connects the filling container device to the mold cavity, and/or within a corresponding filling device. Corresponding detection data can be generated in particular before and/or during the filling of the mold cavity. In order to generate corresponding detection data, detection devices or sensors, i.e. in particular pressure sensors, can be implemented or used. Corresponding detection devices or sensors can be assigned to the mold cavity and/or the filling container device and/or a line connection that connects the filling container device to the mold cavity, and/or a controllable or regulatable pressure-influencing device, in particular in the form of a valve device, assigned to a filling device, formed for example as a filling nozzle or comprising at least one such nozzle.

According to the method, before carrying out the at least one measure for purposefully influencing or varying the difference between the first pressure level and the second pressure level during the filling of the mold cavity, at least one additional measure for purposefully matching the first pressure level and the second pressure level can be carried out, before the filling of the mold cavity. Thus, according to the method, the pressure ratios, i.e. in particular any differences in corresponding pressure levels, can be purposely influenced or varied before the start of the filling of the mold cavity, and thus before the start of a filling process, such that the same or approximately the same pressure levels are present in the filling container device and the mold cavity at the start of the filling of the mold cavity. This can be implemented for example via a corresponding controlled or regulated operation of at least one pressure-influencing device for matching the first pressure level and the second pressure level.

The at least one measure for purposeful matching of the first pressure level and the second pressure level before the filling of the mold cavity can for example include a purposeful increase of the second pressure level, in particular to the first pressure level. Therefore, the pressure level of the mold cavity can be matched to the pressure level of the filling container device before the start of the filling of the mold cavity, which allows for a very easily controllable and comparatively slow flow of the plastics particles into the mold cavity, in any case at the start of a filling process.

If the at least one measure for purposeful matching of the first pressure level and the second pressure level includes a purposeful increase of the second pressure level, in particular to the first pressure level, the measure can be carried out for example by controlling or regulating the operation of at least one controllable or regulatable pressure-influencing device, in particular in the form of a valve device, which is assigned to the mold cavity.

In this case, the control or regulation of the operation of the controllable or regulatable pressure-influencing device assigned to the mold cavity can be carried out on the basis of detection data that describe the pressure level within the mold cavity. In order to generate corresponding detection data, detection devices or sensors, i.e. in particular pressure sensors, can again be implemented or used. Corresponding detection devices or sensors are typically assigned to the mold cavity. However, it is also conceivable to use controllable or regulatable pressure-influencing devices, in particular in the form of valve devices, which are assigned to the filling container device and/or a line connection that connects the filling container device to the mold cavity, and/or a filling device that is formed for example as a filling nozzle or comprises at least one such nozzle.

It is the case, for all embodiments of the method, that the filling of the mold cavity with particle foam material from the filling container device can take place via at least one filling device that is formed for example as a filling nozzle or comprises at least one such nozzle. A corresponding filling device can be designed for generating a conveying stream, i.e. for example a blowing or suction stream, by means of which plastics particles can be conveyed from the filling container device into the mold cavity.

A second aspect of the invention relates to a method for processing particle foam material to produce a particle foam molding. The method comprises the steps of:
providing a particle foam material, to be processed in a mold cavity of a mold for producing a particle foam molding, via at least one filling container device, wherein there is a first pressure level in the filling container device;
providing a mold cavity which is to be filled with a particle foam material that is to be processed for producing a particle foam molding, wherein there is a second pressure level in the mold cavity;
filling the mold cavity with particle foam material from the filling container device, wherein during the filling of the mold cavity a difference between the first pressure level and the second pressure level is purposefully varied or changed by at least one measure for varying the difference between the first pressure level and the second pressure level; and
carrying out at least one measure for connecting the particle foam material filled into the mold cavity, forming a particle foam molding that is to be produced.

The method according to the first aspect can thus constitute a component of the method according to the second aspect of the invention. All the comments in connection with the method according to the first aspect thus apply analogously for the method according to the second aspect of the invention, and vice versa.

The method according to the second aspect generally includes carrying out one or more work processes for processing particle foam material for producing a particle foam molding. The term “work process” essentially includes any process which can be or is carried out within the context of the method, and which is directly or indirectly related to the processing of a particle foam material for producing a particle foam molding.

Therefore, work processes, in particular processing procedures, which can be or are carried out within the context of the method according to the second aspect and in which (actual) processing of particle foam material filled into a mold cavity, i.e. in particular a connection of plastics particles forming a particle foam molding to be produced, takes place. Within the context of a processing procedure, typically at least one work or process fluid stream which flows through the mold cavity that is filled with particle foam material to be processed to a particle foam molding is implemented or used. A work or process fluid that forms a respective work or process fluid stream can be an in particular fluid, vaporous or gaseous energy carrier medium, i.e. for example a liquid, e.g. water, a vapor, e.g. superheated steam, or a gas, e.g. air, which transfers energy, i.e. in particular thermal energy, to the particle foam material within the context of the processing procedure. As is clear in the following, the method relates in particular to a particular process control within the context of corresponding processing procedures.

As mentioned, corresponding provision processes in which an amount of particle foam material to be processed, in particular an amount of particle foam material to be processed in a processing procedure, is provided, conveying processes in which an amount of particle foam material, in particular an amount of particle foam material to be processed in a processing procedure, is conveyed along a conveying path in the direction of a mold cavity, and filling processes in which an amount of particle foam material, in particular an amount of particle foam material to be processed in a processing procedure, is filled into a mold cavity, can be work processes which are also carried out within the context of the method according to the first aspect of the invention.

A third aspect of the invention relates to a device for processing particle foam material to produce a particle foam molding, which device can optionally also be referred to as an automatic molding machine. The device comprises: a mold that defines a mold cavity; a filling container device that is assigned to the mold cavity and is intended for providing particle foam material that is to be filled into the mold cavity within the context of a filling process of the mold cavity; at least one filling device which is designed for filling the mold cavity with particle foam material provided via the filling container device; and at least one controllable or regulatable pressure-influencing device which is designed for carrying out at least one measure for purposely varying a difference between a first pressure level within the filling container device and a second pressure level within the mold cavity during the filling of the mold cavity.

The device can comprise at least one controllable or regulatable pressure-influencing device. A corresponding device can, as mentioned, be designed for example as a valve device, the operation of which is controllable or regulatable. At least one corresponding pressure-influencing device can be assigned to or associated with the filling container device for controlling or regulating the first pressure level within the filling container device, and/or can be assigned to or associated with the mold cavity for controlling or regulating the second pressure level. Furthermore, at least one corresponding pressure-influencing device can be assigned to or associated with a line connection that connects the filling container device to the mold cavity, for controlling or regulating the or a pressure level within the line connection, and/or at least one corresponding pressure-influencing device can be assigned to or associated with the filling device for controlling or regulating the or a pressure level within the filling device.

The device can analogously comprise at least one detection device for detecting a pressure level within the filling container device and/or the mold cavity. A corresponding detection device can for example be formed as a pressure sensor or comprise this. At least one corresponding detection device can be assigned to or associated with the filling container device for detecting the or a first pressure level, and/or can be assigned to or associated with the mold cavity for detecting the or a second pressure level. Furthermore, at least one corresponding detection device can be assigned to or associated with a line connection that connects the filling container device to the mold cavity, for detecting the or a pressure level within the line connection, and/or at least one corresponding detection device can be assigned to or associated with the filling device for detecting the or a pressure level within the filling device.

All the comments in connection with the method according to the first and/or second aspect of the invention apply analogously for the device according to the third aspect of the invention, and vice versa.

The invention is explained in greater detail with reference to embodiments in the drawings, in which:

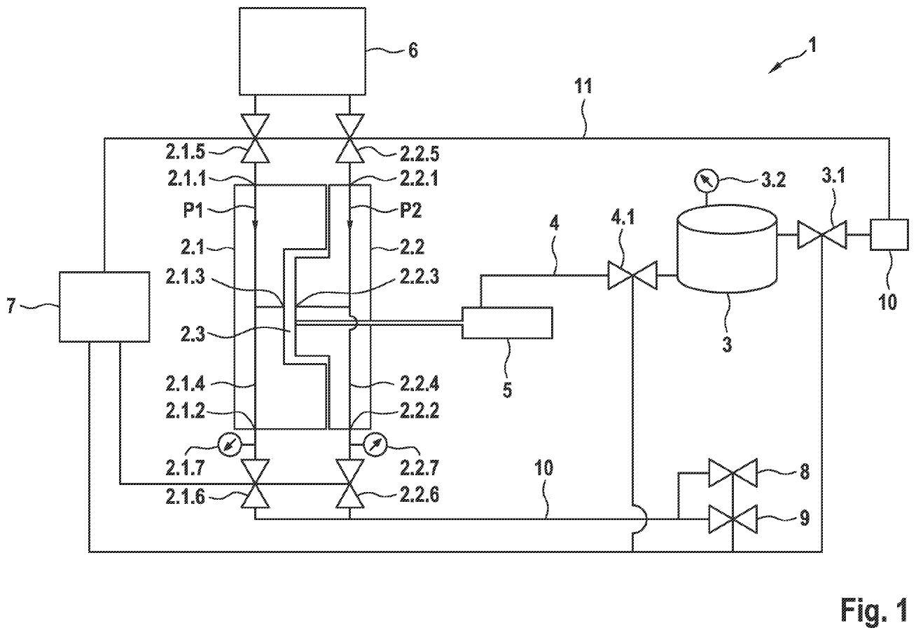

FIG. 1 is a schematic view of a device for processing particle foam material for producing a particle foam molding according to one embodiment; and

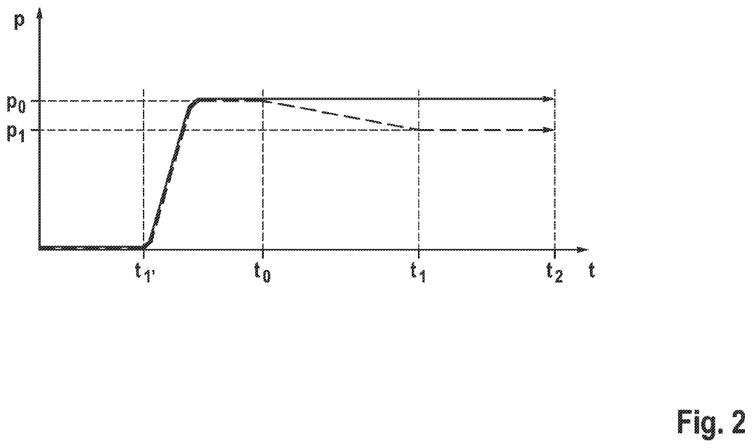

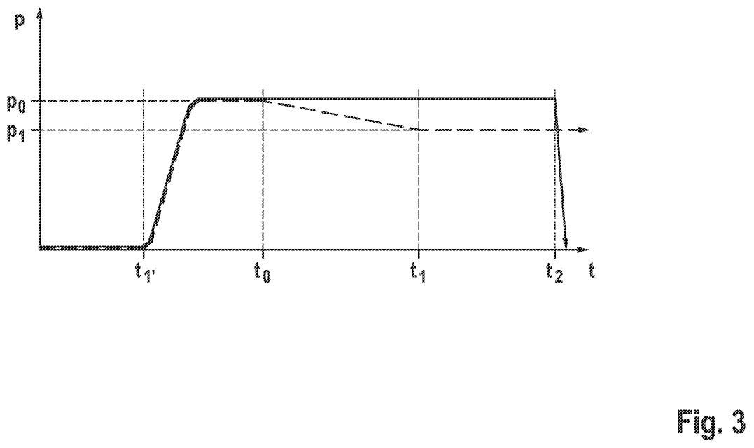

FIGS. 2 and 3 are each graphs for illustrating a method for filling a mold cavity of a mold for producing a particle foam molding using particle foam material, according to one embodiment.

FIG. 1 is a schematic view of a device 1 for processing particle foam material for producing a particle foam molding according to one embodiment.

The device 1, which can also be referred to or is also referred to as a molding machine, is designed for processing an expandable or expanded particle foam material, and thus for processing plastics particles consisting of at least one expandable or expanded plastics particle material, for producing particle foam moldings.

The device 1 is correspondingly designed for carrying out one or more work processes for processing particle foam material for producing a particle foam molding. The term “work process” essentially includes any process which can be carried out by means of the device 1 and which is directly or indirectly related to the processing of a particle foam material for producing a particle foam molding. Work processes that can be carried out by means of the device 1 are in particular processing procedures in which (actual) processing of a particle foam material, i.e. in particular connection of plastics particles, forming a particle foam molding to be produced, takes place, or provision processes in which an amount of particle foam material, in particular an amount of particle foam material to be processed in a processing procedure, is provided, or conveying processes in which an amount of particle foam material, in particular an amount of particle foam material to be processed in a processing procedure, is conveyed along a conveying path, or filling processes in which an amount of particle foam material, in particular an amount of particle foam material to be processed in a processing procedure, is filled into a mold cavity 2.3 of a mold 2 of the device 1.

Within the context of a processing procedure, typically a work or process fluid is introduced or used, which is an in particular fluid, vaporous or gaseous energy carrier medium, i.e. for example a liquid, i.e. in particular water, vapor, i.e. in particular superheated steam, or a gas, which absorbs or outputs energy, i.e. in particular thermal energy, kinematic energy, etc., within the context of the operation of the device.

The device 1 comprises, as a functional unit by way of example, the mold 2 which has already been mentioned and which comprises two mold elements 2.1, 2.2, which can also be referred to as mold halves and which are mounted so as to be movable relative to one another by means of a drive device (not shown) for transferring the mold 1 into at least one closed position, indicated by way of example in FIG. 1, and into at least one open position (not shown in FIG. 1). It can be seen that, in the closed position, the mold elements 2.1, 2.2 delimit or define a mold cavity 2.3.

The mold cavity 2.3 is connected to at least one filling container device 3, which forms a further functional unit of the device 1, by means of a line connection 4, via which filling container device particle foam material for filling the mold cavity 2.3 is provided.

It can be seen that a filling device 5, which forms a further functional unit of the device 1 and is designed for generating a conveying stream, i.e. for example a blowing or suction stream, by means of which particle foam material can be conveyed from the filling container device 3 and into the mold cavity 2.3, is assigned to the line connection 4.

The mold elements 2.1, 2.2 typically each comprise at least one first opening 2.1.1, 2.2.1, which can optionally also be referred to as an inflow opening, and via which a process fluid or a process fluid stream P1, P2 can flow into the respective mold element 2.1, 2.2, and at least one second opening 2.1.2, 2.2.2, which can optionally also be referred to as an outflow opening, and via which a process fluid or a process fluid stream P1, P2 can flow out of the respective mold element 2.1, 2.2. The mold elements 2.1, 2.2 furthermore each comprise at least one third opening 2.1.3, 2.2.3 which is designed to be nozzle-like or nozzle-shaped and via which a process fluid stream that has flowed into the respective mold element 2.1, 2.2 via the respective first opening 2.1.1, 2.2.1 can flow out of the respective mold element 2.1, 2.2 again, into the mold cavity 2.3. In particular in connection with respective third openings 2.1.3, 2.2.3, it is the case that the mold elements 2.1, 2.2 can in each case comprise a plurality of corresponding third openings 2.1.3, 2.2.3. Corresponding third openings 2.1.3, 2.3.3 are in particular arranged or formed in the region of respective shaping mold element portions of the respective mold elements 2.1, 2.2. In the same way, venting of the mold cavity 2.3 can be achieved via respective third openings 2.1.3, 2.2.3.

The respective first, second and third openings 2.1.1-2.1.3, 2.2.1-2.2.3 of a respective mold element 2.1, 2.2 are typically fluidically interconnected via a flow channel structure 2.1.4, 2.2.4 that comprises at least one flow channel (not denoted) that passes through the respective mold element 2.1, 2.2, at least in portions, such that a process fluid stream that has flowed into the respective mold element 2.1, 2.2 via a respective first opening 2.1.1, 2.2.1 can flow out of the respective mold element 2.1, 2.2 via a respective second opening 2.1.2, 2.2.2 and/or via a respective third opening 2.1.3, 2.2.3. A corresponding flow channel structure 2.1.4, 2.2.4 can in each case extend close to the contour, at least in portions, i.e. closely under the respective shaping mold element portions of respective mold elements 2.1, 2.2, for example in order, when a process fluid stream flows through, to allow for an energy transfer from the respective mold element portion to the or a particle foam material filled into the mold cavity 2.3.

In the embodiment shown in FIG. 1, at least one pressure-influencing device 2.1.5, 2.1.6, 2.2.5, 2.2.6, in each case, is assigned to respective first and second openings 2.1.1, 2.1.2, 2.2.1, 2.2.2 on the mold element side. In the embodiment, corresponding pressure-influencing devices 2.1.5, 2.1.6, 2.2.5, 2.2.6 are formed as valve devices which are controllable or regulatable in their operation, and typically comprise at least one valve element (not shown) which is movable along a lift path between at least one first position, which can also be referred to as the open position and in which a flow of a process fluid stream through the respective pressure-influencing device 2.1.5, 2.1.6, 2.2.5, 2.2.6 is possible, and at least one second position, which can also be referred to as the closed position and in which a flow of a process fluid stream through the respective pressure-influencing device 2.1.5, 2.1.6, 2.2.5, 2.2.6 is not possible. Depending on the specific design of a respective pressure-influencing device 2.1.5, 2.1.6, 2.2.5, 2.2.6, a corresponding valve element can typically also be moved into at least one intermediate position located between a corresponding first and second position.

It is clear in the embodiment shown in FIG. 1 that at least one pressure-influencing device 3.1, 4.1 is also assigned to the filling container device 3 and the line connection 4. In this case, it should be noted that at least the pressure-influencing device 4.1 is optional. Alternatively or in addition, a material flow-influencing device can be present at the corresponding location, which device is designed to influence the material flow exiting from the filling container device 3. The pressure-influencing devices 3.1, 4.1 can be designed analogously to the pressure-influencing devices 2.1.5, 2.1.6, 2.2.5, 2.2.6 assigned to the mold elements 2.1, 2.2.

Moreover, further pressure-influencing devices 8, 9 can be present, which are arranged downstream of the pressure-influencing devices 2.1.6, 2.2.6 on the mold element side and are connected thereto by means of a common line connection 10. The pressure-influencing devices 8, 9 arranged in parallel, by way of example, in FIG. 1 can likewise be designed analogously to the pressure-influencing devices 2.1.5, 2.1.6, 2.2.5, 2.2.6 assigned to the mold elements 2.1, 2.2.

The device 1 comprises, as a further functional unit, a conveying fluid provision device 10 which is designed to provide the filling container device 3 with a conveying fluid, to which pressure is optionally applied, for example compressed air, for forming a conveying stream, by means of which located within the filling container device 3 can be transported into the mold cavity 2.3. It is clear that the conveying fluid provision device 10 can likewise be connected via the line connection 11 to the assigned pressure-influencing devices 2.1.5, 2.2.5, in order to optionally also provide a corresponding conveying fluid to the mold cavity 2.3, e.g. for what is known as “blowing out” of the mold cavity 2.3.

The device 1 comprises, as a further functional unit, a process fluid provision device 6, which is designed to provide a process fluid, for forming the first process fluid flow, selectively to the first mold element 2.1 and/or the second mold element 2.2. The process fluid provision device 6 can for example comprise a container device which is filled with process fluid, optionally conditioned to a specific temperature and/or a specific pressure, for provision to the first and/or second mold element 2.1, 2.2.

The device 1 comprises, as a further functional unit, a computer-implemented, i.e. in particular hardware- and/or software-implemented, control and/or regulation device 7, which is designed to produce control or regulation information for controlling or regulating the operation of respective pressure-influencing devices 2.1.5, 2.1.6, 2.2.5, 2.2.6, in particular in such a way that the first and the second process fluid stream P1, P2 differ in the at least one flow parameter that influences the flow properties.

The device 1 comprises, as further functional units, detection devices 2.1.7, 2.2.7 and 3.2 for detecting a pressure level within the mold cavity 2.3 and/or within the filling container device 3. The detection devices 2.1.7, 2.2.7 and 3.2 can in each case be formed as a pressure sensor or comprise this. Furthermore, even if this is not shown, at least one corresponding detection device for detecting the or a pressure level within the line connection 4 can be assigned to or associated with the line connection 4, and/or at least one corresponding detection device for detecting the or a pressure level within the filling device 5 can be assigned to or associated with the filling device 5.

In addition to a method for processing particle foam material for producing a particle foam material, a method for filling a mold cavity 2.3 of a mold 2 for producing a particle foam molding can also be implemented by means of the configuration of the device 1 shown by way of example in FIG. 1. An embodiment of a corresponding method for filling a mold cavity 2.3 of a mold 2 is explained by way of example in the following, with reference to FIGS. 1 and 2:

In a first step of the method, particle foam material, to be processed in a mold cavity 2.3 of a mold 2 for producing a particle foam molding, is provided via at least one filling container device 3, wherein there is a first pressure level in the filling container device 3. The particle foam material is furthermore to be filled into at least one mold cavity 2.3 of a mold 2, within the context of a filling process, and, after completion of the filling process, to be processed in the mold cavity 2.3 for producing a particle foam molding, within the context of a, for example steam-based, processing procedure. The filling container device 3, which is designed for example as a pressure vessel or comprises at least one such vessel, comprises a filling container volume which can be or is filled with particle foam material and in which, in any case in the state filled with particle foam material, a pressure level referred to in the following as “first pressure level”, and thus a specified first pressure, prevails.

In a second step of the method, at least one mold cavity 2.3 which is to be filled with a particle foam material that is to be processed for producing the or a particle foam molding is provided, wherein there is a second pressure level in the mold cavity 2.3. The particle foam material that is to be or is filled into the mold cavity 2.3 within the context of a corresponding filling process is, as mentioned, to be processed, after completion of the filling process, in the mold cavity 2.3 for producing a particle foam molding, within the context of a, for example steam-based, processing procedure. The mold cavity 2.3, which is defined by a plurality of mold elements 2.1, 2.2, which are also referred to in each case as mold halves, comprises a mold cavity volume which can be or is filled with particle foam material and in which, in any case in the state not filled with particle foam material, a pressure level referred to in the following as “second pressure level”, and thus a specified second pressure, prevails.

The first and the second step of the method can be carried out simultaneously or in reverse order; all that is important, for carrying out the method, is that particle foam material, to be processed in a mold cavity 2.3 of a mold for producing a particle foam molding, is provided via at least one filling container device 3, wherein there is a first pressure level in the filling container device 3, and that a mold cavity 2.3, to be filled with particle foam material to be processed for producing the or a particle foam molding, is provided, wherein there is a second pressure level in the mold cavity 2.3.

As emerges in the following, the pressure levels within the filling container device 3 and within the mold cavity 2.3 can differ within the context of a filling process, i.e. during the filling of the mold cavity 2.3 with particle foam material. In particular, within the context of a corresponding filling process the second pressure level can differ from the first pressure level in that it is below the first pressure level.

In a third step of the method, the mold cavity 2.3 is filled with particle foam material from the filling container device 3. Accordingly, in the third step of the method a corresponding filling process is carried out, within the scope of which particle foam material from the filling container device 3 is filled into the mold cavity 2.3, and therefore the mold cavity 2.3 is filled with particle foam material from the filling container device 3.

According to the method, during the filling the mold cavity 2.3, and therefore while carrying out a corresponding filling process in the context of which particle foam material is conveyed from the filling container device 3 via the or a corresponding line connection 4 and into the mold cavity 2.3, a difference between the first pressure level and the second pressure level is varied or changed in a purposeful manner by at least one measure for varying or changing the difference between the first pressure level and the second pressure level. Thus, according to the method, existing differences between the first and the second pressure level are varied or changed in a purposeful manner during the filling of the mold cavity 2.3. The purposeful variation or change of corresponding differences between the first and the second pressure level is performed with the aim of an improved filling process which allows in particular higher filling densities or levels of the mold cavity and, associated therewith, higher molding weights of the particle foam moldings that can be produced.

The principle according to the method makes it possible, by means of corresponding purposeful variation or change of the or a difference between corresponding pressure levels, in particular to implement a controlled or regulated volume flow of a particle foam material from the or a corresponding filling container device 3 into the or a corresponding mold cavity 2.3. The speed at which the particle foam material is conveyed into the mold cavity 2.3, within the context of a filling process, can be controlled or regulated in a corresponding manner. The individual plastics particles can be conveyed into the mold cavity 2.3 at greater compression and/or slower speed by the purposeful variation or change in the difference between the pressure levels, which can be understood to mean, as is clear in the following, also a matching of the pressure levels following a previous purposeful change or increase in the difference of the pressure levels, which results in an improved, because it is more densely packed, filling of the mold cavity 2.3. Specifically, more significantly compressed plastics particles, which are conveyed into the mold cavity 2.3 at lower speed, for example collect better in corners of the mold cavity 2.3, such that said corners, as well as other regions of a mold cavity 2.3 that can typically be filled only with difficulty, such as regions far away from a filling opening of a mold element 2.2, can be filled in a significantly more controllable and reproducible manner, with high filling densities or levels, by means of the principle according to the method.

The at least one measure for purposeful variation or changing of the difference between corresponding first and second pressure levels can presuppose a, for example sensor-based, detection of corresponding first and second pressure levels, such that, proceeding from specifically detected first and second pressure levels and, associated therewith, a specifically detected difference between corresponding pressure levels, a purposeful variation or change of the difference between the pressure levels can take place. The detection of the pressure levels can take place for example by means of the detection devices explained above in connection with the device 1, i.e. in particular the detection devices 2.1.7, 2.2.7 and/or 3.2.

As is likewise clear in the following, the at least one measure for purposeful variation or changing of the difference between corresponding first and second pressure levels can be implemented by means of control or regulation technology. In particular, for purposeful variation or change of the difference between corresponding pressure levels, active or passive pressure-influencing devices 2.1.5, 2.1.6, 2.2.5, 2.2.6, 3.1, 4.1, which, as mentioned, can in each case be valve devices that are controllable or regulatable with regard to their operation, i.e. in particular control or regulation valve devices, or proportional valve devices, can be implemented or used, the operation of which is controlled or regulated in a particular manner, for example, for purposeful variation or change of the difference between corresponding pressure levels.

The control or regulation of the operation of corresponding pressure-influencing devices 2.1.5, 2.1.6, 2.2.5, 2.2.6, 3.1, 4.1 can include for example a specification of control or regulation information describing a lifting movement or a lifting process of at least one lifting element, mounted so as to be movable along a lifting path, of corresponding pressure-influencing devices 2.1.5, 2.1.6, 2.2.5, 2.2.6, 3.1, 4.1, and the implementation of corresponding lifting movements or lifting processes of a corresponding lifting element, on the basis of corresponding control or regulation information.

Specific measures for purposeful variation or changing of the or a difference between the or a corresponding first pressure level and the or a corresponding second pressure level, which measures can be carried out within the context of the method, are explained by way of example in the following, with reference to FIGS. 2 and 3:

In this respect, FIG. 2 shows a graph for illustrating the variation or change of corresponding pressure levels, wherein the pressure p indicating the respective pressure level is plotted on the y-axis, and the time t is plotted on the x-axis. The solid line relates to the pressure level within the filling container device 3, the dashed line relates to the pressure level within the mold cavity 2.3. The start of the filling process of the mold cavity 2.3 is indicated by the timepoint t₀.

With reference to FIG. 2, it can first generally be seen that a measure for purposefully varying or changing the or a difference between the first pressure level and the second pressure level during the filling of the mold cavity 2.3 can include setting a defined difference, which can be changed, in particular in a time-dependent and thus dynamic manner, between the first pressure level and the second pressure level. Within the context of the implementation of the at least one measure, differences between the first pressure level and the second pressure level which can be changed in a purposeful manner, in particular in a time-dependent manner, can thus be achieved during filling of the mold cavity 2.3.

This can in general be implemented by a control or regulation, taking place in particular in a time-dependent and thus dynamic manner, of the operation of corresponding pressure-influencing devices 2.1.5, 2.1.6, 2.2.5, 2.2.6, 3.1, 4.1. For this purpose, in particular the pressure-influencing devices 2.1.5, 2.1.6, 2.2.5, 2.2.6 assigned to the mold 2, and the further pressure-influencing devices 8, 9, are to be controlled or regulated in a corresponding manner, with respect to their operation.

In particular, it can be the case that, as soon as the conveying stream out of the filling container device 3 conveys a conveying fluid into the mold cavity 2.3, the pressure-influencing devices 2.1.5, 2.2.5 are typically closed. The conveying stream additionally introduced into the mold cavity 2.3 can be discharged in a controlled manner via the pressure-influencing device 8, in order to regulate the second pressure level correspondingly. Since in this case a conveying stream escapes out of the filling container device 3 into the mold cavity 2.3, the first pressure level can be correspondingly readjusted by means of the pressure-influencing device 3.1.

The setting of corresponding differences, which can be changed in a time-dependent manner, between the first pressure level and the second pressure level during the filling of the mold cavity 2.3 can include a time-dependent increase or decrease in the or a pressure difference between the first pressure level and the second pressure level. A corresponding sometimes time-dependent increase or decrease in the or a pressure difference between the first pressure level and the second pressure level can be continuous or non-continuous, or linear or non-linear. Specifically, as shown by way of example in FIG. 2, the second pressure level can be increased or decreased relative to the first pressure level; the first pressure level does not necessarily have to be changed in the process.

Therefore, a ramp-like or ramp-shaped decrease in the second pressure level from a first pressure value p₀ (starting pressure value) at the timepoint t₀, i.e. immediately at the start of the filling process, to a lower second pressure value p₁ (end pressure value) at the timepoint t₁, i.e. after a defined time interval following the start of the filling process, is to be cited as an example for a continuous or linear increase or decrease in the or a pressure difference between the first pressure level and the second pressure level. The setting, possible according to the method, of a defined difference, which can be changed in particular in a time-dependent manner, between the first pressure level and the second pressure level, during the filling of the mold cavity 2.3, can thus include a ramp-like or ramp-shaped continuous reduction of the second pressure level from a defined, starting pressure value p₀, typically selected in a particle foam-specific and/or mold-specific manner, before or at the start of the filling of the mold cavity 2.3, to a defined end pressure value p₁, likewise typically selected in a particle foam-specific and/or mold-specific manner, after a defined time interval, i.e. in particular the time interval between the timepoints t₀ and t₁, has elapsed after the start of the filling of the mold cavity 2.3.

A corresponding decrease of the second pressure level can take place in a range between 1 and 90%, more particularly in a range between 1 and 80%, more particularly in a range between 1 and 70%, more particularly in a range between 1 and 60%, more particularly in a range between 1 and 50%, more particularly in a range between 1 and 40%, more particularly in a range between 1 and 30%, more particularly in a range between 1 and 20%, more particularly in a range between 1 and 10%.

The decrease of the second pressure level, shown, as mentioned, purely by way of example in FIG. 2, can be implemented in general for example via a controlled or regulated operation of corresponding pressure-influencing devices 2.1.5, 2.1.6, 2.2.5, 2.2.6, 3.1, 4.1 for implementing a corresponding ramp-like or ramp-shaped increase or decrease of the second pressure level. Again, for this purpose, in particular the pressure-influencing devices 2.1.5, 2.1.6, 2.2.5, 2.2.6 assigned to the mold 2 are to be controlled or regulated in a corresponding manner, with respect to their operation.

It is thus clear from FIG. 2 that the setting of a defined difference, which can be changed in a time-dependent manner, between the first pressure level and the second pressure level can take place, according to the method, in general immediately at the start of the filling of the mold cavity 2.3, and thus immediately at the start of a filling process.

With reference to FIG. 2, it can furthermore be seen that the or a measure for varying or changing the difference between the first pressure level and the second pressure level during the filling of the mold cavity 2.3 can include, in particular in addition, setting a defined difference, which is unchangeable, in a time-dependent manner, between the first pressure level and the second pressure level. A corresponding setting, which is unchangeable in a time-dependent manner, of a defined unchangeable difference between the first pressure level and the second pressure level, can thus include maintaining a constant difference and thus, in any case in view of the compression of the plastics particles and/or the speed of the plastics particles, the occasional implementation of a stationary filling process.

This can be implemented in general for example via a corresponding controlled or regulated operation of one or more of the pressure-influencing devices 2.1.5, 2.1.6, 2.2.5, 2.2.6, 3.1, 4.1, 8, 9 for setting a difference, which is unchangeable, in particular in a time-dependent manner, between the first pressure level and the second pressure level. Again, for this purpose, corresponding pressure-influencing devices 2.1.5, 2.1.6, 2.2.5, 2.2.6, 8, 9 which are directly or indirectly assigned to the mold 2 are to be controlled or regulated in a corresponding manner, with respect to their operation.

Taken as a whole, FIG. 2 shows that combinations of the above-mentioned possibilities for purposeful influencing or varying of a difference between a first and a second pressure level are conceivable.

The at least one measure for varying the difference between the first pressure level and the second pressure level during the filling of the mold cavity can thus include firstly setting a defined difference, which can be changed in a time-dependent manner, between the first pressure level and the second pressure level, over a first time interval between the timepoints t₀ and t_{1′}, i.e. directly at the start of the filling at the timepoint t₀ up to the timepoint t_{1′}, and, after the first time interval has elapsed, setting a defined difference, which is unchangeable, in a time-dependent manner, between the first pressure level and the second pressure level, e.g. until the end of a filling process at the timepoint t₂.

Therefore, as shown in FIG. 2, a purposeful time-dependent change of the difference between the first pressure level and the second pressure level, i.e. in particular an increase in the difference between the first pressure level and the second pressure level, can take place immediately during or after the start of the filling of the mold cavity 2.3, initially for a first time interval, and then, in particularly immediately, after the first time interval has elapsed, maintenance of a difference, present after the first time interval has elapsed, between the first pressure level and the second pressure level, can take place.

This can be implemented in general for example via a corresponding controlled or regulated operation of corresponding pressure-influencing devices 2.1.5, 2.1.6, 2.2.5, 2.2.6, 3.1, 4.1, 8, 9, initially for setting a defined difference, which can be changed in a time-dependent manner, between the first pressure level and the second pressure level, over a first time interval after the start of the filling, and after the first time interval has elapsed, setting a defined difference, which is unchangeable, in particular in a time-dependent manner, between the first pressure level and the second pressure level. Again, for this purpose, in particular the pressure-influencing devices 2.1.5, 2.1.6, 2.2.5, 2.2.6, 8, 9 that are directly or indirectly assigned to the mold 2 are to be controlled or regulated in a corresponding manner, with respect to their operation.

According to the method, the setting of a defined difference, which can be changed and/or is unchangeable in a time-dependent manner, between the first pressure level and the second pressure level, during the filling of the mold cavity 2.3, can, according to the method, in general include a purposeful matching or setting of (only) the second pressure level from a starting value before or at the start of the filling of the mold cavity 2.3, i.e. before the start of a corresponding filling process, to a defined end value after a defined time interval has elapsed after the start of the filling of the mold cavity 2.3, i.e. after the start of a corresponding filling process. Therefore, according to the method, the pressure level within the mold cavity 2.3 can be purposely varied or changed during the filling of the mold cavity 2.3. Alternatively or additionally, however, the pressure level within the filling container device 3 and/or within a line connection 4 that connects the filling container device 3 to the mold cavity 2.3, and/or within a filling device 5 that is for example formed as a filling nozzle or comprises at least one such nozzle, can be purposely varied or changed.

Finally, with reference to FIG. 2, it can be seen that, according to the method, before carrying out the at least one measure for purposefully influencing or varying the difference between the first pressure level and the second pressure level during the filling of the mold cavity 2.3, and thus before the timepoint t₀, at least one additional measure for purposefully matching the first pressure level and the second pressure level is carried out, before the filling of the mold cavity 2.3. The matching of the first pressure level and the second pressure level before the filling of the mold cavity 2.3 is shown in FIG. 2, by way of example, in the time interval between the timepoints t_{1′} and to. Thus, according to the method, the pressure ratios, i.e. in particular any differences in corresponding pressure levels, can be purposely influenced or varied before the start of the filling of the mold cavity 2.3, and thus before the start of a filling process, such that the same or approximately the same pressure levels are present in the filling container device 3 and the mold cavity 2.3 at the start of the filling of the mold cavity 2.3—as shown by way of example in FIG. 2—at the timepoint t₀.

This can be implemented for example via a corresponding controlled or regulated operation of corresponding pressure-influencing devices 2.1.5, 2.1.6, 2.2.5, 2.2.6, 3.1, 4.1, 8, 9 for matching the first pressure level and the second pressure level. For this purpose, in particular the pressure-influencing devices 2.1.5, 2.1.6, 2.2.5, 2.2.6, 8, 9 that are directly or indirectly assigned to the mold 2 and the pressure-influencing device 3.1 assigned to the filling container device 3 are to be controlled or regulated in a corresponding manner, with respect to their operation.

The at least one measure for purposeful matching of the first pressure level and the second pressure level before the filling of the mold cavity can for example include a purposeful increase of the second pressure level, in particular to the first pressure level. Therefore, the pressure level of the mold cavity 2.3 can be matched to the pressure level of the filling container device 3 before the start of the filling of the mold cavity 2.3, which allows for a very easily controllable and comparatively slow flow of the plastics particles into the mold cavity, in any case at the start of a filling process.

Again it is generally noted that the control or regulation of the operation of the controllable or regulatable pressure-influencing devices 2.1.5, 2.1.6, 2.2.5, 2.2.6, 3.1, 4.1, 8, 9 can be carried out essentially on the basis of detection data that describe the pressure level within the filling container device 3 and/or within the mold cavity 2.3 and/or within the line connection 4 and/or within the filling device 5. Corresponding detection data can be generated via the described detection devices 2.1.7, 2.2.7 and 3.2, and transmitted to the control and/or regulating device 7 for generating corresponding control and/or regulation information.

FIG. 3 shows a graph for illustrating the variation or change of corresponding pressure levels according to a possible variant, wherein again the pressure p indicating the respective pressure level is plotted on the y-axis, and the time t is plotted on the x-axis. The solid line again relates to the pressure level within the filling container device 3, the dashed line again relates to the pressure level within the mold cavity 2.3. The start of the filling process of the mold cavity 2.3 is indicated by the timepoint t₀. The completion of the filling process of the mold cavity 2.3 is in turn indicated by the timepoint t₂.

Finally, with reference to FIG. 3, it can be seen that the pressure level within the filling container device 3 can be significantly reduced, after the completion of the filling process, i.e. at the timepoint t₂, in order to move excess particle foam material, in particular out of the filling device 4, in the direction of the filling container device 3. This process can thus be referred to as what is known as secondary filling.

1. Method for filling a mold cavity of a mold for producing a particle foam molding using particle foam material, the method comprising:
providing particle foam material, to be processed in a mold cavity of a mold for producing a particle foam molding, via at least one filling container device, wherein there is a first pressure level in the filling container device;
providing a mold cavity which is to be filled with a particle foam material that is to be processed for producing the or a particle foam molding, wherein there is a second pressure level in the mold cavity;
filling the mold cavity with particle foam material from the filling container device, wherein during the filling of the mold cavity a difference between the first pressure level and the second pressure level is purposefully varied by at least one measure for varying the difference between the first pressure level and the second pressure level.

2. Method according to claim 1, wherein the at least one measure for varying the difference between the first pressure level and the second pressure level during the filling of the mold cavity includes setting a defined difference, which can be changed, in particular in a time-dependent manner, between the first pressure level and the second pressure level.

3. Method according to claim 2, wherein the setting of a defined difference, which can be changed, in particular in a time-dependent manner, between the first pressure level and the second pressure level includes a continuous, in particular ramp-like, reduction of the second pressure level from a starting value before the start of the filling of the mold cavity to a defined end value after a defined time interval has elapsed after the start of the filling of the mold cavity.

4. Method according to claim 1, wherein the at least one measure for varying the difference between the first pressure level and the second pressure level during the filling of the mold cavity includes setting a defined difference, which is unchangeable, in particular in a time-dependent manner, between the first pressure level and the second pressure level.

5. Method according to claim 2, wherein the at least one measure for varying the difference between the first pressure level and the second pressure level during the filling of the mold cavity includes firstly setting a defined difference, which can be changed in a time-dependent manner, between the first pressure level and the second pressure level, over a first time interval after the start of the filling, and, after the first time interval has elapsed, setting a defined difference, which is unchangeable, in particular in a time-dependent manner, between the first pressure level and the second pressure level.

6. Method according to claim 1, wherein the at least one measure for varying the difference between the first pressure level and the second pressure level is carried out by controlling or regulating the operation of at least one controllable or regulatable pressure-influencing device, in particular in the form of a valve device, which is assigned to the mold cavity and/or to the filling container device.

7. Method according to claim 6, wherein the control or regulation of the operation of the controllable or regulatable pressure-influencing device which is assigned to the mold cavity and/or to the filling container device is carried out on the basis of detection data that describe the pressure level within the mold cavity and/or within the filling container device.

8. Method according to claim 1, wherein before carrying out the at least one measure for varying the difference between the first pressure level and the second pressure level, at least one additional measure for matching the first pressure level and the second pressure level is carried out.

9. Method according to claim 8, wherein the at least one measure includes increasing the second pressure level, in particular to the first pressure level.

10. Method according to claim 8, wherein the at least one measure for matching the first pressure level and the second pressure level is carried out by controlling or regulating the operation of at least one controllable or regulatable pressure-influencing device, in particular in the form of a valve device, which is assigned to the mold cavity.

11. Method according to claim 10, wherein the control or regulation of the operation of the controllable or regulatable pressure-influencing device assigned to the mold cavity and/or the filling container device is carried out on the basis of detection data that describe the pressure level within the mold cavity and/or the filling container device.

12. Method for processing particle foam material to produce a particle foam molding, the method comprising:
providing particle foam material, to be processed in a mold cavity of a mold for producing a particle foam molding, via at least one filling container device, wherein there is a first pressure level in the filling container device;
providing a mold cavity which is to be filled with a particle foam material that is to be processed for producing a particle foam molding, wherein there is a second pressure level in the mold cavity;
filling the mold cavity with particle foam material from the filling container device, wherein during the filling of the mold cavity a difference between the first pressure level and the second pressure level is purposefully varied by at least one measure for varying the difference between the first pressure level and the second pressure level; and
carrying out at least one measure for connecting the particle foam material filled into the mold cavity, forming a particle foam molding that is to be produced.

13. Device for processing particle foam material to produce a particle foam molding, the device comprising:
a mold that defines a mold cavity,
a filling container device that is assigned to the mold cavity and is intended for providing particle foam material that is to be filled into the mold cavity within the context of a filling process of the mold cavity,
at least one filling device which is designed for filling the mold cavity with particle foam material provided via the filling container device,
at least one controllable or regulatable pressure-influencing device which is designed for carrying out at least one measure for purposely varying a difference between a first pressure level within the filling container device and a second pressure level within the mold cavity during the filling of the mold cavity with particle foam material.

14. Device according to claim 13, wherein the at least one controllable or regulatable pressure-influencing device is assigned to the mold cavity and/or the filling container device.

15. Device according to claim 13, wherein at least one detection device which is assigned to the mold cavity and/or the filling container device and which is designed for detecting the pressure level within the mold cavity and/or within the filling container device.
